(19) United States
(12) Patent Application Publication
(10) Pub. No.: US 2011/0090236 A1
(43) Pub. Date: Apr. 21, 2011

(54) Graphic Object Data Binding

(75) Inventors: Martin Calsyn, Cambridge (GB); Alexander Brändle, Cambridge (GB); Drew Purves, Cambridge (GB)

(73) Assignee: Microsoft Corporation, Redmond, WA (US)

(21) Appl. No.: 12/579,989

(22) Filed: Oct. 15, 2009

(51) Int. Cl. G09G 5/00; G06F 9/45

(52) U.S. Cl. 345/581; 717/144; 717/140

(57) ABSTRACT

Graphic object data binding is described. In an embodiment, the display of a graphic object having a visual property is updated when a trigger is received. The graphic object is updated by accessing a record of dependency data to determine a dependency of the visual property on stored source data, and updating the visual property of the graphic object on the display device in accordance with the source data. In another embodiment, a compiler receives source code comprising a statement binding the visual property of the graphic object to the source data. A processor reads the source code, detects the statement, generates a record of dependency data linking the visual property of the graphic object to the source data, stores the record of dependency data, and generates executable code. The executable code is output from the compiler, and can be executed by a computing device to display the graphic object.

### BACKGROUND

User interfaces, applications and websites viewed on modern computing devices make extensive use of graphics to provide information to users. The graphics are defined using a programming language to control the look and behavior of the graphics, and rendered on-screen by a graphic subsystem that interprets the programming language.

Traditionally, programmers link data to graphical elements using iterative execution of imperative program statements. In other words, programmers use trial and error to define how the graphics appear and behave for certain data inputs. This can be a time-consuming and imprecise method, and is consequently excessively complex and frequently results in the graphical programs being implemented in a sub-optimal fashion.

This is exacerbated by the increased availability of both fixed and mobile computing devices able to display graphic-intensive and engaging applications (both local and web-based), which has consequently driven the demand for the development of such applications. Many developers attempting to develop such graphical applications are therefore nascent programmers, who are not skilled in graphical programming, and hence are not able to create efficient code for displaying graphics.

The embodiments described below are not limited to implementations which solve any or all of the disadvantages of known graphical programming or rendering techniques.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Graphic object data binding is described. In an embodiment, the display of a graphic object having a visual property is updated when a trigger is received. The graphic object is updated by accessing a record of dependency data to determine a dependency of the visual property on stored source data, and updating the visual property of the graphic object on the display device in accordance with the source data. In another embodiment, a compiler receives source code comprising a statement binding the visual property of the graphic object to the source data. A processor reads the source code, detects the statement, generates a record of dependency data linking the visual property of the graphic object to the source data, stores the record of dependency data, and generates executable code. The executable code is output from the compiler, and can be executed by a computing device to display the graphic object.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a workflow for graphic object generation and display;

FIG. 2 illustrates an example display of graphic objects and an associated dependency graph;

FIG. 3 illustrates a polling-based wrapper object for source data;

FIG. 4 illustrates an event-based wrapper object for source data;

FIG. 5 illustrates a flowchart of a polling-based graphic object update process;

FIG. 6 illustrates a flowchart of an event-based graphic object update process;

FIG. 7 illustrates an example display of a collection of graphic objects; and

FIG. 8 illustrates an exemplary computing-based device in which embodiments of the graphic object data binding can be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a desktop computing system, the system described is provided as an example and not a limitation. As those skilled in the art will appreciate, the present examples are suitable for application in a variety of different types of computing systems.

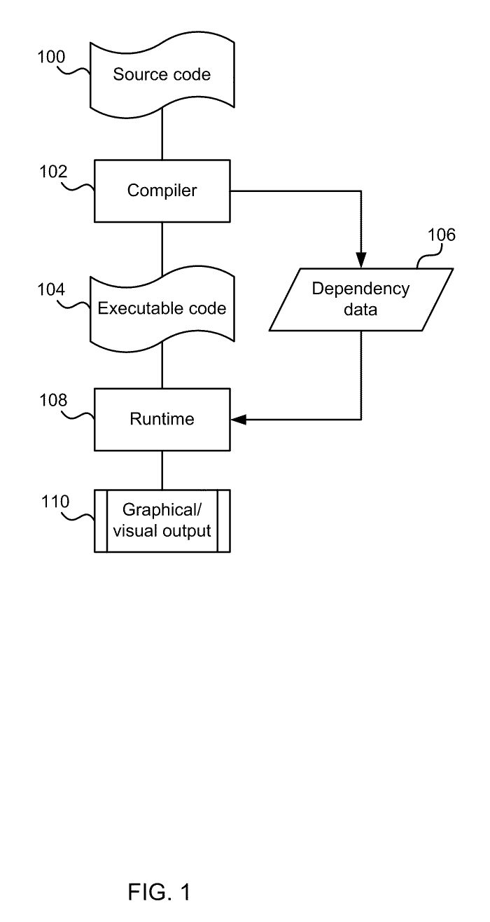

Reference is first made to FIG. 1, which illustrates a workflow for generating and displaying a graphic object on a computing device. The term graphic object is used herein to refer to a visually perceivable item displayed on a display device connected to a computing device. A graphic object can be, for example, a shape or collection of shapes, a rendered scene, or an image. A graphic object can also be a graphic user interface feature, such as a text box (i.e. a text input or display field), or other user-operable graphical user interface control (such as a button, slider, knob, menu, etc.)

The first stage in the workflow of FIG. 1 is the generation of source code 100. The source code 100 defines the properties and behavior of the graphic object. Note that the source code 100 can also define many other operations and functions of an application, in addition to aspects related to the graphic object. The source code 100 is provided in a programming language defined herein that comprises instructions to link or bind one or more visual properties of the graphic object to specific data. In other words, one or more visual properties or attributes of the graphic object are can be made dependent on the data, such that the visual properties change as the data changes. This enables a nascent programmer to readily and efficiently link graphic objects and their visual properties directly to data and computations.

Note that the term visual property is used herein to mean a visually perceivable attribute of the graphical object, such as, for example, its size, shape, color, orientation, position of display on the display device, textual information displayed on or in association with the graphic object, and visibility on the display device (i.e. whether it is displayed or hidden).

Two syntactic constructs in the programming language are used to facilitate the unidirectional and bidirectional binding of data to graphical objects in a form that is syntactically and semantically approachable by nascent programmers. The first syntactic construct is a unidirectional binding statement. A unidirectional binding can be defined in the source code 100 as a statement of the form:
target:=source;

Where ‘:=’ is the unidirectional binding operator, ‘source’ is the source of the data for the binding and ‘target’ is the property of the graphical object that receives any changes that are detected in the source data. The return value of this expression is a ‘binding’ and the evaluation of this expression has the side-effect of making entries in a binding dependency graph (described in more detail hereinafter).

The programming language of the source code 100 enables the binding to be assigned to a variable, for example:
b=target:=source;

Where ‘b’ is the variable assigned the binding. This can be used to act on and control the binding directly. For example, the variable can be used to cancel (or delete) the binding, for example using:
b.Cancel( );

Once deleted, the binding no longer updates the target when the source changes. To facilitate the generation of more complex relations between graphic objects (targets) and source data, unidirectional bindings can be combined, for example as:
e1:=e2:=e3;

In this example expression, ‘e2’ is updated whenever the value of ‘e3’ changes and ‘e1’ is updated whenever the value of ‘e2’ changes (whether that change occurs due to this binding or some other external or programmatic effect). Target expressions can also be lambda expressions, such as:
e1:=(x)=>Transmogrify(x)*0.1:=e2;

The effect of this example statement is that the lambda expression ‘Transmogrify(x)*0.1’ is executed whenever the value of ‘e2’ changes (i.e. the changed value of e2 is provided as the argument x to the lambda expression) and ‘e1’ is updated with a new value if the result of the lambda expression differs from e1's current value. The type and dimensionality of the lambda expression is compatible with the value emitted by e2 and the type and dimensionality of e1 is compatible with that of the result of the lambda expression. Binding expressions can also return tuples or lists, if the type and dimensionality of sources and targets is consistent.

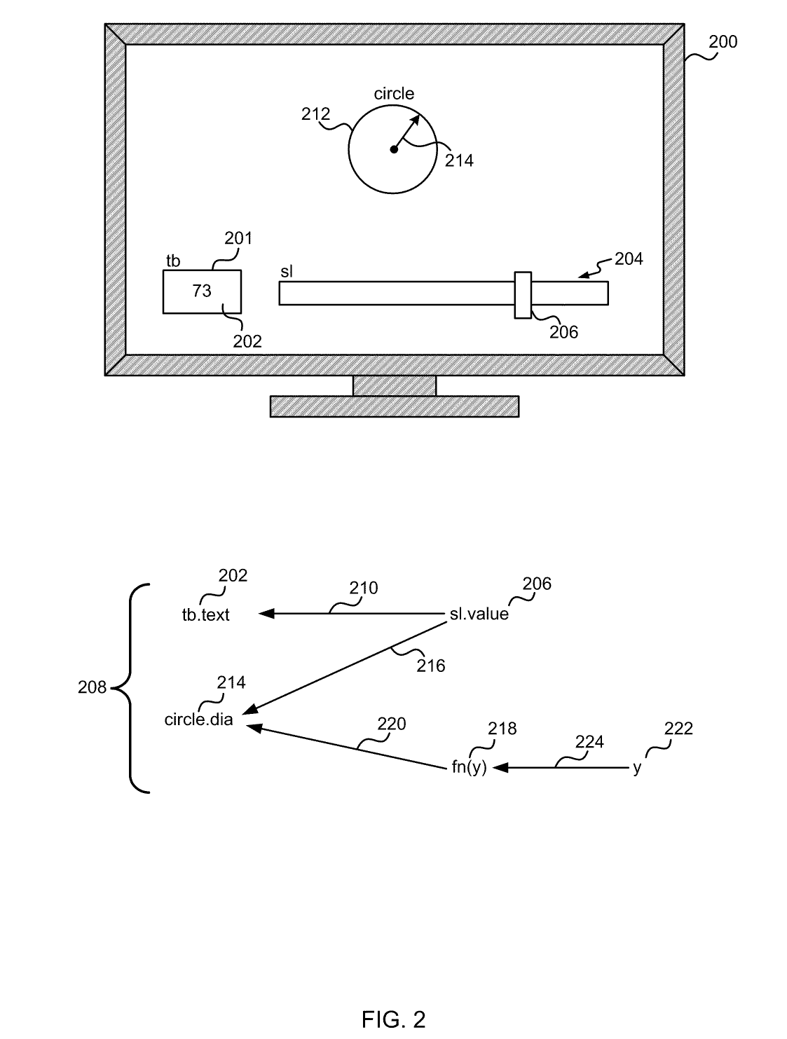

The use of this syntactic construct is illustrated with reference to FIG. 2. In this example, the programmer defines a number of graphic objects for display on a display device 200 connected to a computing device (not shown in FIG. 2). Firstly, a text box 201 (denoted ‘tb’ in the source code) is arranged to display text 202 (in this case a numerical value). Secondly, a slider 204 (denoted ‘sl’ in the source code) is arranged to be operable by a user (e.g. using a pointing device) to select a value from a range using a movable selector 206. Thirdly, a circle 212 is displayed which has a diameter 214.

In this example, the programmer wishes to define an inter-relationship between the graphical objects, such that the text box 201 displays the value selected by the user using the movable selector 206, and the circle diameter 214 is also related to the selector 206 value (by some function). This can be achieved using the unidirectional binding operator with the statements:

tb.text := sl.value;
circle.dia := fn(y) * sl.value;

Where the visual property of the text 202 displayed in the text box 201 is defined by the attribute ‘tb.text’, the value of the slider 204 selected by the user is defined by the attribute ‘sl.value’, and the diameter 214 of the circle 212 is defined by the attribute ‘circle.dia’. The function ‘fn(y)’ is some function defined by another part of the source code taking another variable ‘y’ as an argument. The above statements therefore bind the text 202 displayed in the text box 201 to the slider 204 value, such that as the user moves the selector 206, the text 202 in the text box 201 changes accordingly. In addition, as the user moves the selector 206 the size of the diameter 214 of the circle 212 also changes in dependence on the value of the slider 204 multiplied by the result of the function fn(y). This example therefore illustrates that the programmer is able to define complex interdependencies between graphical objects and data using a very compact set of expressions.

In addition to the unidirectional bindings outlined above, the second syntactic construct is a bidirectional binding statement. A bidirectional binding can be defined in the source code 100 as a statement of the form:
object1:=:object2;

Where ‘:=:’ is the bidirectional binding operator. Bidirectional bindings are an expansion of the unidirectional bindings in that object2 is the source for object1, and object1 is also the source for object2. For example, the text box 201 and slider 204 of FIG. 2 can be bound using a bidirectional binding, as follows:
tb.text:=:sl.value;

In this case, a change in the position of the movable selector 206 by the user causes the text 202 in the text box 201 to be updated. In addition, if the user enters a value into the text box 201 (e.g. using a keyboard) this causes the position of the selector 206 on the slider 204 to update to reflect the value entered. In a bidirectional binding, each side of the expression is a valid target (in type and dimensionality) for the result of the other side of the expression.

Returning again to FIG. 1, once the source code 100 has been generated to define the graphic objects and the bindings to source data, the source code 100 can be input to a compiler 102 for compilation. The compiler 102 is arranged to generate computer executable code 104 from the source code 100. The compiler 102 is configured to interpret the binding statements and construct the executable code 104 accordingly.

When compiling source code comprising the above-defined binding statements, the compiler 102 performs two functions. The first is the generation of a dependency graph, and the second is wrapping of source data.

Whenever a source-target relationship is created using a binding statement, that relationship is recorded as dependency data 106. The dependency data 106 is stored in the form of a dependency graph. The dependency graph indicates which targets are dependent on which sources. The dependency graph is a directed acyclic graph, which avoids infinite loops in the source-target relationships.

FIG. 2 illustrates an example dependency graph 208 for the example graphic objects displayed on the display device 200 in FIG. 2 (and described above). When the compiler 102 compiles source code having the binding statements above for generating the graphic objects and their inter-relationships illustrated FIG. 2, the dependency graph 208 is generated. The dependency graph 208 has nodes corresponding to the targets and sources, and edges connecting the sources to the targets. For example, the dependency graph 208 indicates that the text 202 (tb.text) displayed in the text box 201 is dependent on the slider 204 value set by the selector 206 (sl.value). Similarly, the circle 212 diameter 214 (circle.dia) is dependent on both the slider 204 value set by the selector 206 (sl.value) and the function fn(y) 218, and that the function fn(y) 218 is in turn dependent on the variable y 222.

The dependency graph 208 therefore enables the dependency of any target to be traced to one or more sources. This ensures that the impact of a change in a source can be linked to the correct target graphic object, as outlined in more detail hereinafter. As stated, the dependency graph is created as part of the compilation process and stored as dependency data 106. The dependency data 106 can be stored as part of the executable code 104 output from the compiler 102, or as separate data.

The second function performed by the compiler mentioned above is wrapping of source data. The wrapping of source data is performed in order to enable the tracking of changes to the source data. In other words, the wrapping is used to detect changes to the ‘source’ in the expression ‘target:=source’.

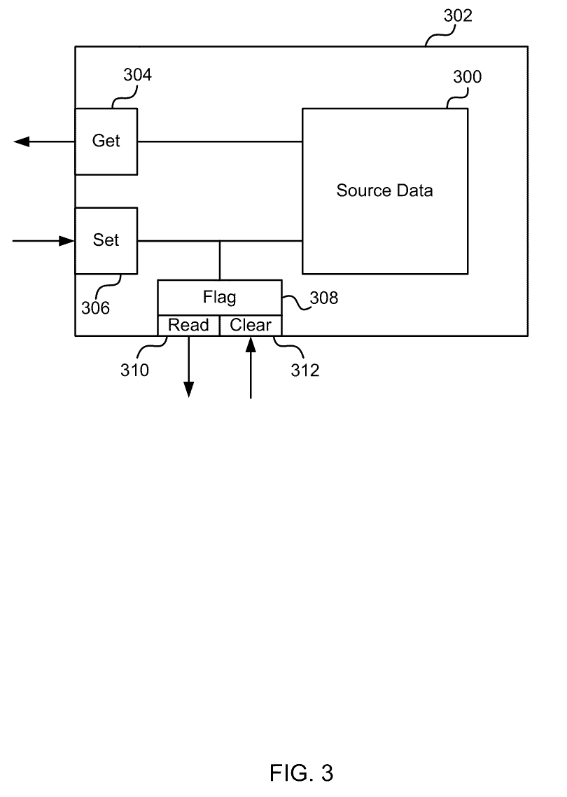

A first example wrapper is illustrated in FIG. 3. FIG. 3 illustrates the wrapping of source data 300 in what is known herein as a polling-based wrapper 302. The compiler 102 provides a wrapper 302 around the source data 300 such that specific interfaces to the source data 300 are available. For example, the compiler 102 provides a ‘get’ interface 304 and ‘set’ interface 306 to the source data 300. In other words, the source becomes an object with a setter and getter method.

The wrapper 302 also comprises a flag element 308, which can be considered to operate as a ‘dirty’ flag. In other words, whenever a write is made to the source, via the set interface 306, the flag element 308 is set (e.g. given a value of true). The value of the flag element 308 can be accessed via a read interface 310, and the flag element 308 cleared using a clear interface 312.

At any point in the source code 100 where an assignment request is made to source data 300, that assignment is translated into a ‘set’ operation on the wrapper 302 wrapping ‘source’. When the assignment code is executed, the set operation sets the value of the source data 300 and sets the flag element 308. In any instance in the source code 100 where the source data is queried, e.g. when used as the right-hand-side of a normal assignment or as part of an expression, this is converted into a ‘get’ operation on the source data 300.

By maintaining the flag element 308, it can be ascertained (using the read interface 310) whether the source data 300 has changed. Once a change in the source data 300 has been detected and acted on, the flag element 308 can be cleared using the clear interface 312 to enable future detection of further changes.

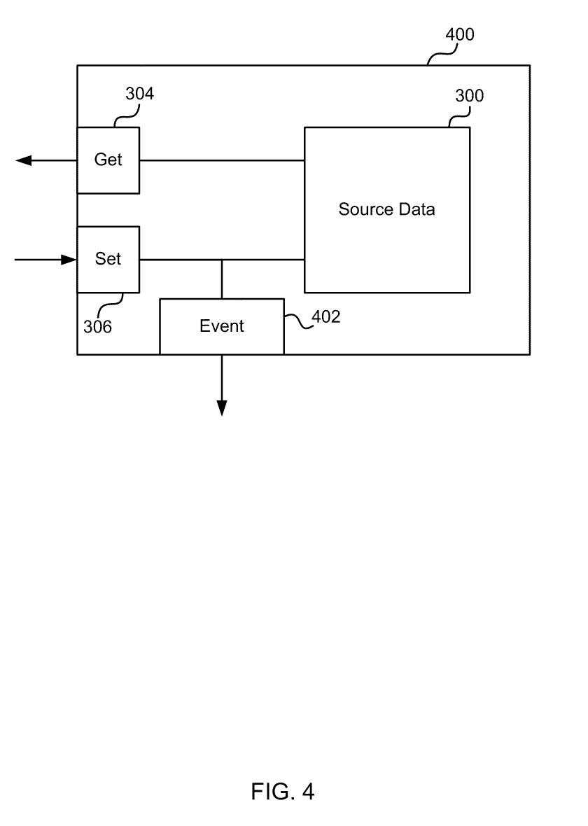

A second example wrapper is illustrated in FIG. 4. FIG. 4 illustrates the wrapping of source data 300 in what is known herein as an event-based wrapper 400. As with FIG. 3, the compiler 102 provides the wrapper 400 around the source data 300, and provides a get interface 304 and set interface 306 to the source data 300.

The wrapper 400 of FIG. 4 also comprises an event monitor 402. The event monitor 402 is connected to the set interface 306, such that whenever a write is made to the source via the set interface 306, the event monitor 402 generates and transmits a notification message. The notification message indicates to the recipient that the source data 300 has been changed.

In common with FIG. 3, for the event-based technique, at any point in the source code 100 where an assignment request is made to source data 300, that assignment is translated into a ‘set’ operation on the wrapper 400 wrapping the source data. When the assignment code is executed, the set operation sets the value of the source data and triggers the event monitor 402. In any instance in the source code 100 where the source data is queried, e.g. when used as the right-hand-side of a normal assignment or as part of an expression, this is converted into a ‘get’ operation on the source data 300.

The generation of wrappers (either polling-based or event-based) by the compiler therefore changes the treatment of the source data throughout the source code 100. The compiler 102 is configured to detect all variables implicated as sources in bindings and perform the wrapping of these variables. This not only includes simple variables that act as sources, but also any variables that appear in expressions that appear in binding source expressions.

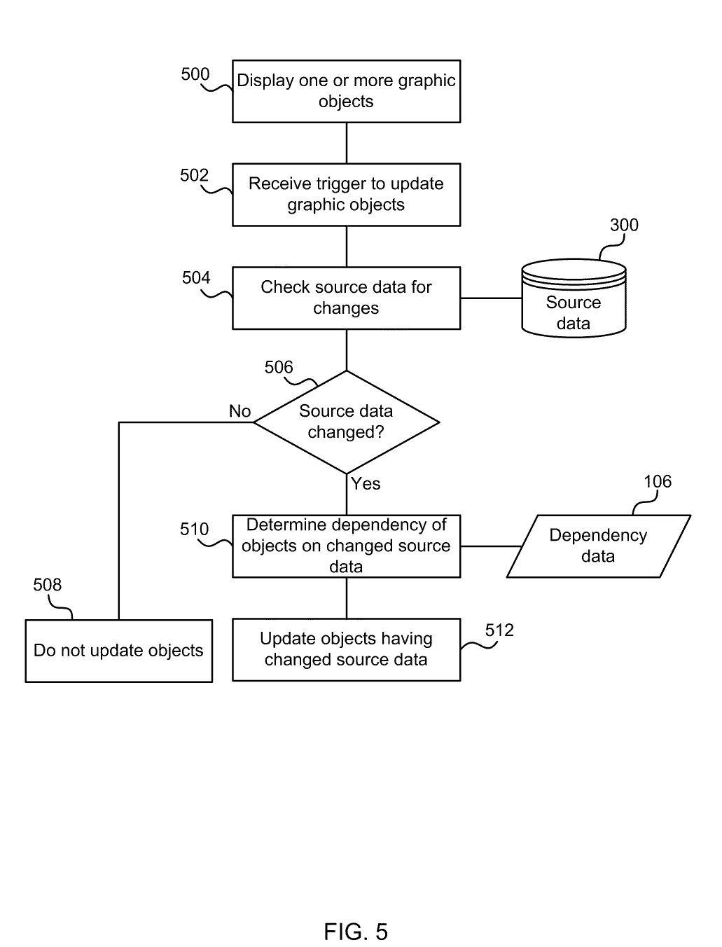

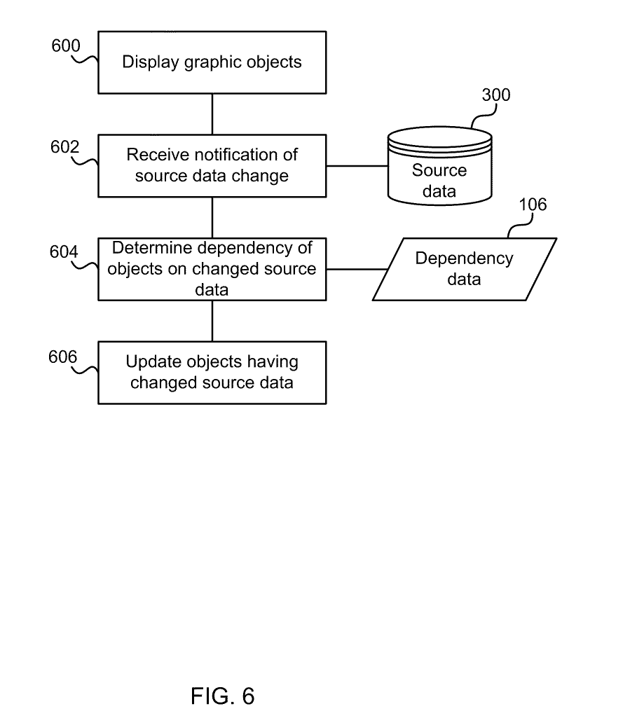

Returning again to FIG. 1, once the compilation is complete, the executable code 104 (comprising the wrapped sources) and the dependency data 106 is generated. The executable code 104 can then be executed at runtime 108 to produce a graphical output 110 (e.g. as illustrated in the display device 200 of FIG. 2). The operation of the executable code 104 at runtime is now illustrated with reference to FIGS. 5 and 6, which illustrate flowcharts for using the polling-based and event-based techniques, respectively.

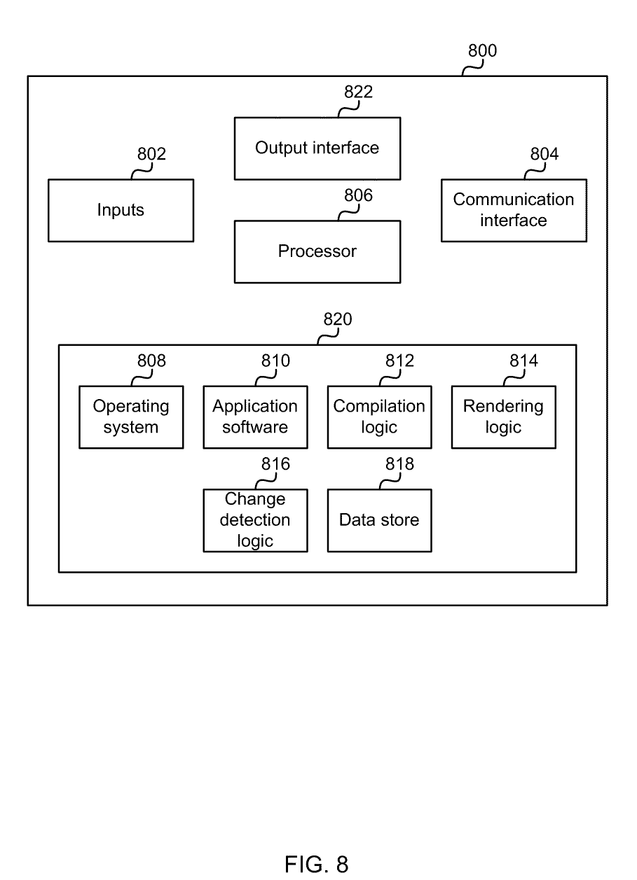

FIG. 5 shows a flowchart of a runtime process for displaying and updating a graphic object using the polling-based technique. In other words, the flowchart shown in FIG. 5 is used when the compiler 102 compiles the source code 100 and uses the polling-based wrappers 302 of FIG. 3. The runtime process of FIG. 5 is executed using one or more processors of a computing device (such as that illustrated in FIG. 8 described hereinafter) and connected to a display device. This can be a different computing device to that used to compile the source code.

Initially, one or more graphic objects are displayed 500 on the display device 200 in an initial state (e.g. as shown in FIG. 2). After a time period, a trigger is received 502 to update the graphic objects if appropriate. The trigger can be in the form of a periodic update signal arranged to trigger the update to occur at regular time intervals. For example, the periodic update signal can be set to update the graphic objects at the frame refresh rate for the overall scene displayed on the display device. In alternative examples, each of the individual graphic objects displayed can have their own update intervals, such that particular triggers update specific graphic objects.

Responsive to receiving the update trigger, the processor checks 504 the source data 300 for changes. Because this process is using the polling-based technique, this is achieved by checking the flag element 308 using the read interface 310 of the wrapper 302 for each item acting as source data 300. A change in the source data 300 is detected if the flag element 308 is set.

If it is determined 506 that none of the source data 300 has changed, then updates to the graphic objects are not required 508. However, if it is determined 506 that at least one source data item has changed since the previous update, then an update is appropriate. To perform the update, it is determined which graphic objects are dependent on the changed source data. This is achieved by accessing the dependency data 106, and traversing the dependency graph to determine the graphic object (or objects) dependent on a given (i.e. the changed) source data. In other words, the dependency graph is used to determine every target that is dependent on the changed source.

For example, referring to the dependency graph 208 of FIG. 2, if the polling of the source data reveals that ‘sl.value’ has its flag element set, then this indicates that the value of this has changed since the previous update. The dependency graph 208 can be traversed to determine that a change in ‘sl.value’ impacts both the text 202 in the text box 201 and the diameter 214 of the circle 212. Similarly, if a change is detected in the value of ‘y’, then traversing the dependency graph 208 indicates that only the diameter 214 of the circle 212 is to be updated, and not the text 202 in the text box 201.

Once the dependency data 106 has been used to determine which graphic objects are dependent on the changed source data, these graphic objects can be updated 512 in accordance with the changed source data. For example, the graphic objects dependent on the changed source data are updated in accordance with the relation defined in the source code 100, which, as stated above, can be a direct relation with the source data, or via one or more other bindings, functions (e.g. lambda expressions), variables or constants. For each target (e.g. graphic object) in the dependency graph that is updated, if that target is also the source in some other binding, the dependency graph indicates that relationship and enables the update of those targets as well, and so on until every implicated target is updated.

Once the graphic objects dependent on the changed source data are updated, the flag elements for the changed source data can be cleared (e.g. using the clear interface 312). The above-described process therefore enables the graphic objects to be updated in a computationally efficient manner, as the use of the dependency graph enables only a subset of graphic objects to be updated as appropriate for the particular source data that has changed. This is achieved without complex programming constructs in the source code 100.

Note that, in some cases, a variable (e.g. a variable ‘x’) can be the target of one binding and also a source in another binding and also have further been directly written to programmatically since the last polling cycle. In such instances, the processor applies a heuristic to determine whether the direct write to x takes precedence over the update of x as the result of the binding and which value is to be propagated to x's binding target. In one example, that heuristic determines that a direct writes to x takes precedence.

Reference is now made to FIG. 6, which shows a similar runtime flowchart as FIG. 5 for displaying and updating a graphic object, but instead using the event-based technique. Hence, the process of FIG. 6 is used when the compiler 102 compiles the source code 100 and uses the event-based wrappers 400 of FIG. 4. As above, the runtime process of FIG. 6 is executed using one or more processors of a computing device (such as that illustrated in FIG. 8 described hereinafter) and connected to a display device. This can be a different computing device to that used to compile the source code.

One or more graphic objects are firstly displayed 600 on the display device 200. A trigger is received 602 in the form of a notification of a source data change, as a result of an event monitor 402 detecting a change in the source data 300 and transmitting the notification message. Therefore, when the event-based technique is being used, the processor does not need to poll the source data to determine whether a change has occurred. Rather, the source data wrapper 400 proactively notifies that a change has occurred.

Responsive to receiving the notification message, the processor determines 604 which graphic objects are dependent on the changed source data. This is achieved in a similar manner as described above with reference to FIG. 5, i.e. by accessing the dependency data 106, and traversing the dependency graph to determine the graphic object (or objects) dependent on the changed source data.

Once the dependency data 106 has been used to determine which graphic objects are dependent on the changed source data, these graphic objects are updated 606 in accordance with the changed source data. This is in accordance with the relation defined in the source code 100, which, as stated above, can be a direct relation with the source data, or via one or more other bindings, functions (e.g. lambda expressions), variables or constants.

In alternative examples, the processor can aggregate several notification messages before performing the remainder of the update process. In other words, the processor does act immediately after receiving a notification message, but instead batches notification message over a period of time. Like the process of FIG. 5, the process of FIG. 6 enables the graphic objects to be updated in a computationally efficient manner, as the use of the dependency graph enables only a subset of graphic objects to be updated as appropriate for the particular source data that has changed, without complex programming constructs in the source code 100.

Note that the polling-based and event-based techniques can be combined within a single executable program, such that some source data uses polling to check for changes, and other source data generates events. In such cases, the flowchart of FIG. 5 is used for the source data utilizing polling, and FIG. 6 is used for the source data that generates events. The polling method can be used to batch-update only those targets whose source has changed. The event-driven approach can be utilized if the binding mechanism is to be used to drive reactive programming constructs (e.g. writing information to file rather than updating a display).

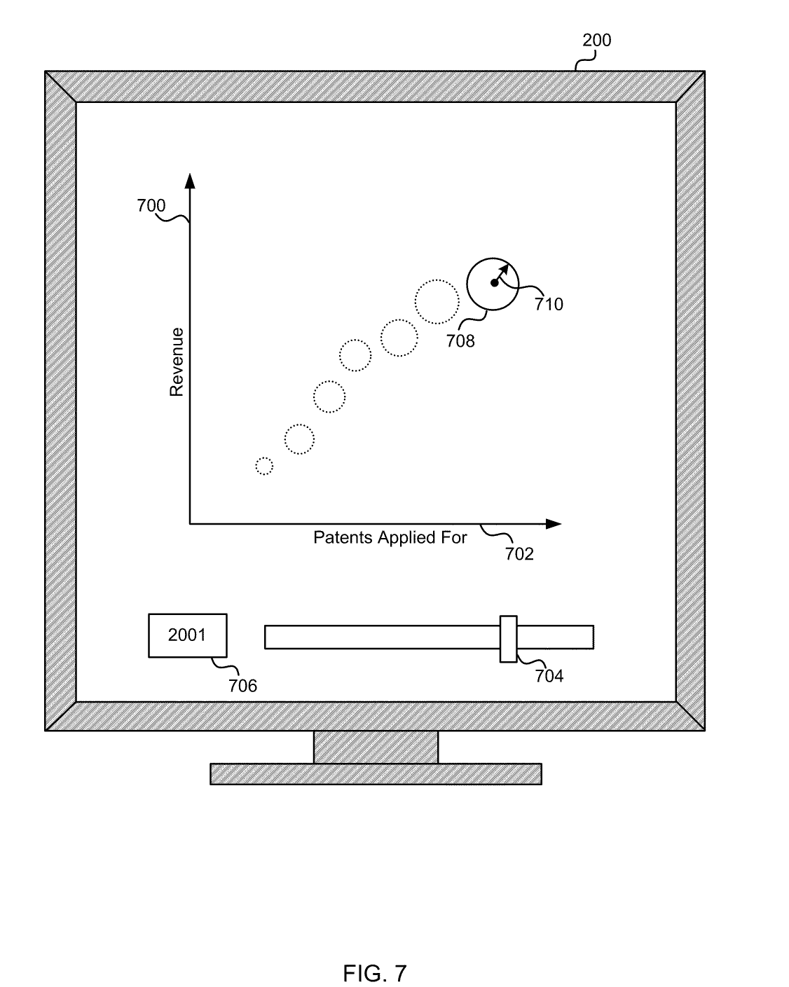

Reference is now made to FIG. 7, which illustrates the use of the binding constructs for the display of graphical objects bound to collections of data, and the manner in which they can be used to generate complex on-screen displays with a compact and simple set of instructions.

A plurality of visual properties or attributes of graphical objects can be bound to a data ‘collection’. The term ‘collection’ is used herein to refer to a vector of values, for example a data set in a rows-and-columns table arrangement. The binding construct can be used, for example, to bind several attributes of a graphic object to entries in a collection (e.g. color from one entry in a row, size from another in the row, etc.) In this way, if a value within the collection is changed, the corresponding attribute of the graphic object also changes. Furthermore, ‘observable’ collections can also be used such that if the collection as a whole changes (e.g. through the addition or deletion of one or more rows or columns), then this can be detected, and the graphic object updated or additional graphic objects created accordingly.

The binding of collections and observable collections enables the coupling of graphic objects to data elements in a predictable fashion. For example, the table below shows an illustrative time-series of data. In this example, the time-series (in years) shows the number of patents applied for, revenue and number of patents granted for a given company.

| | Patents Applied | | |
|---|---|---|---|
| Time | For | Revenue | Patents Granted |
| 1980 | 54 | 54M | 21 |
| 1981 | 58 | 62M | 29 |
| . . . | . . . | . . . | . . . |
| 2007 | 238 | 234M | 98 |
| 2008 | 268 | 359M | 109 |

The binding constructs enable a data collection such as this to be readily displayed as a dynamic interactive graphical visualization. For example, to display this data in the form of an interactive bubble-chart, the following code can be used:

```
ds = dataset(“example.csv”);
t := sl.value;
tb.text := sl.value;
circles := from row in ds
        where ds.time = t;
        select new circle( )
        {
            radius = row.granted;
            x = row.applications;
            y = row.revenue;
        };
scene.add(circles);
```

The effect of this code, when compiled and executed, is illustrated in FIG. 7. FIG. 7 shows several graphic objects displayed on display device 200. A y-axis 700 representing revenue and an x-axis 702 representing the number of patents applied for are shown. In addition, a slider 704 enables a user to select a time value from those in the data collection (e.g. 1980 to 2008 in the table above). A text box 706 is displayed next to the slider 704. Note that the code to display the axes, slider and textbox is not shown above.

In the above code, the data collection is stored in a file (in this case a comma separated value file) called example.csv, which holds the data in the above table. In other examples, the data collection is stored in one or more different types of files, or in one or more databases (e.g. in an SQL database). The files or databases can be local to the computing device or stored remotely (e.g. on a server). The data collection is assigned to a variable ‘ds’. A variable ‘t’ is bound to the value of the slider 704, such that ‘t’ is given the value selected by the user operating the slider 704. In addition, the text of the text box 706 is bound to the value of the slider 704, such that the value selected by the user operating the slider 704 is shown in the text box 706.

A graphic object called ‘circles’ is bound to the data collection. The row of the data set ‘ds’ is selected from the variable ‘t’ (which in turn is bound to the slider value). Therefore, the selection of the slider 704 value determines the row of the data collection being read. For the selected row, a circle 708 is created. The circle 708 is given its visual properties from the data set ‘ds’. For example, the circle 708 is given a diameter 710 in accordance with the number of granted patents from the selected row, an x location on the x-axis 702 in accordance with the number of patents applied for entry in the selected row, and a y location on the y-axis 700 in accordance with the revenue entry in the selected row. At the end of the code, the circles are added to the displayed scene.

Therefore, when the code is executed, as the value of time is selected and changed by the user using the slider 704 the circle 708 displayed on the axes changes to reflect the data for the selected time. The runtime operation is similar to that described above with reference to FIGS. 5 and 6. In this way, the user is able to create a complex graphic representation, such as a bubble chart, using very few lines of code. In addition, the code is computationally efficient as only the graphic objects that change as the selected time is varied are updated.

The above-described code can also be enhanced such that the visual properties of the circle update independently of a change to the selected time. For example, the statements ‘radius=row.granted’, ‘x=row.applications’, ‘y=row.revenue’ can be replaced with ‘radius:=row.granted’, ‘x:=row.applications’, ‘y:=row.revenue’. The effect of this is that the visual properties are bound to the entries within the data set, as well as being bound to the data set as a whole. Therefore, if a change is made to the entries within the data set of the displayed row, this is reflected in the visual properties of the circle 708.

In this example, the data set defines the visual properties of a single graphic object (the circle) as they change over a time series. In other examples, further data sets can also be included to represent the additional time-series data (e.g. data for additional companies), and code similar to that above can be used to add additional graphic objects bound to each additional data set (e.g. an additional circle for each company). Each circle can be provided with a visual property to identify the data set (e.g. such as a different color circle for each company).

In further examples, the rows of the data set could each define the properties of a different graphic object. For example, each row in the data set can define the x and y values of a single bar in a histogram, and each bar in the histogram can be displayed using a different graphic object.

Reference is now made to FIG. 8, which illustrates various components of an exemplary computing-based device 800 which can be implemented as any form of a computing and/or electronic device, and in which embodiments of either or both of the compiler 102 or the runtime 108 from FIG. 1 can be implemented.

The computing-based device 800 comprises one or more inputs 802 which are of any suitable type for receiving user input, for example the source code 100 or the executable code 104, or direct input from the user, e.g. in the form of input from a keyboard and/or a pointing device, or any other suitable human-computer interface. The computing-based device 800 also comprises at least one communication interface 804 for communicating with one or more communication networks, such as the internet (e.g. using Internet protocol (IP)) or a local network. The communication interface 804 can be used to communicate with one or more external computing devices, such as servers, databases or storage devices.

Computing-based device 800 also comprises one or more processors 806 which can be microprocessors, controllers or any other suitable type of processors for processing computing executable instructions to control the operation of the device in order to compile source code comprising binding graphic objects to data, or execute compiled code comprising such bindings. Platform software comprising an operating system 808 or any other suitable platform software can be provided at the computing-based device 800 to enable application software 810 to be executed on the device.

Further software that can be executed on the computing-based device includes: compilation logic 812, which implements the functionality of the compiler 102 described hereinbefore; rendering logic 814 arranged to display graphic objects on the screen in accordance with the runtime processes described above; and change detection logic 816 arranged to detect changes in source data. A data store 818 can be provided to store either or both of the dependency data and source data.

The computer executable instructions, software and/or data store can be provided using any computer-readable media, such as memory 820. The memory 820 is of any suitable type such as random access memory (RAM), a disk storage device of any type such as a magnetic or optical storage device, a hard disk drive, or a CD, DVD or other disc drive. Flash memory, EPROM or EEPROM can also be used.

An output interface 822 is also provided such as a video and/or audio output to a display system (e.g. display device 200) integral with or in communication with the computing-based device 800. The display system can provide the display of the graphic objects to the user as part of a graphical user interface.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as appropriate, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A computer-implemented method of displaying a graphic object having a visual property on a display device, comprising:
receiving a trigger to update the graphic object on the display device;
accessing a record of dependency data to determine a dependency of the visual property on stored source data; and
updating the visual property of the graphic object on the display device in accordance with the source data.

2. A method according to claim 1, further comprising the step of determining whether the source data has changed since a previous update of the graphic object on the display device responsive to receiving the trigger.

3. A method according to claim 2, wherein the step of determining whether the source data has changed comprises at least one of: determining whether a data value in the source data has been updated; determining whether a new data value has been added to the source data; and
determining whether a data value has been deleted from the source data.

4. A method according to claim 1, wherein the trigger is a periodic update signal.

5. A method according to claim 4, wherein periodic update signal is generated at a frame refresh rate for the display device.

6. A method according to claim 1, wherein the trigger is a message notifying a change in the source data.

7. A method according to claim 6, wherein message is generated by an event monitor arranged to detect a change in the source data and generate the message responsive thereto.

8. A method according to claim 1, wherein the visual property comprises at least one of: size; shape; color; orientation; display position; displayed text; and visibility on the display device.

9. A method according to claim 1, wherein the source data comprises at least one of: a data file; a database; a value input from a user; a value from an evaluated function; a lambda expression; and a predefined constant.

10. A method according to claim 1, wherein the graphic object comprises at least one of: a shape; a collection of shapes; a scene; an image; a text box; and a user operable graphical user interface control.

11. A compiler, comprising:
an input arranged to receive source code comprising at least one statement binding a visual property of a graphic object to source data;
a processor arranged to read the source code, detect the at least one statement, generate from the at least one statement a record of dependency data linking the visual property of the graphic object to the source data, store the record of dependency data, and generate executable code from the source code; and
an output arranged to output the executable code.

12. A compiler according to claim 11, wherein the processor is further arranged to wrap the source data in a wrapper object providing a plurality of interfaces to the source data.

13. A compiler according to claim 12, wherein the plurality of interfaces comprises a get interface arranged to return the source data value responsive to a query.

14. A compiler according to claim 12, wherein the plurality of interfaces comprises a set interface arranged to write a value to the source data value responsive to a request.

15. A compiler according to claim 12, wherein the wrapper object comprises a flag element arranged to be set responsive to at least one of: a value being written to the source data; a value being added to the source data; a value being deleted from the source data.

16. A compiler according to claim 12, wherein the wrapper object comprises an event monitor arranged to generate and transmit a message indicating a change in the source data responsive to at least one of: a value being written to the source data; a value being added to the source data; a value being deleted from the source data.

17. A compiler according to claim 11, wherein the record of dependency data is a dependency graph.

18. A compiler according to claim 11, wherein the dependency graph is a directed acyclic graph.

19. A computer-implemented method of displaying a plurality of graphic objects on a display device, each having a visual property, comprising:
receiving a trigger to update the plurality of graphic objects on the display device;
accessing a stored source data set and detecting that a portion of the source data set has changed since a previous update;
responsive to detecting a changed portion of the source data set, accessing a stored dependency graph to identify at least one of the plurality of graphic objects having a visual property dependent on the changed portion of the source data set; and
updating the visual property of the at least one identified graphic object on the display device in accordance with the changed portion of the source data set.

20. A method according to claim 19, wherein the step of detecting that a portion of the source data set has changed since a previous update comprises at least one of:
detecting that at least one data value within the source data set has changed;
detecting that a row of data values has been added to the source data set;
detecting that a column of data values has been added to the source data set;
detecting that a row of data values has been deleted from the source data set; and
detecting that a column of data values has been deleted from the source data set.
